(19) United States
(12) Patent Application Publication
(10) Pub. No.: US 2025/0119232 A1
(43) Pub. Date: Apr. 10, 2025

(54) MODIFICATION OF MODULATION AND CODING SCHEME

(71) Applicant: QUALCOMM Incorporated, San Diego, CA (US)

(72) Inventors: Diana MAAMARI, San Diego, CA (US); Peter GAAL, San Diego, CA (US); Prashanth Haridas HANDE, San Diego, CA (US); Chih-Ping LI, San Diego, CA (US); Mickael MONDET, Louannec (FR); Belal Salama Amin KORANY, San Diego, CA (US); Zhichao ZHOU, Beijing (CN); Ahmed ELSHAFIE, San Diego, CA (US)

(21) Appl. No.: 18/868,055

(22) PCT Filed: Aug. 1, 2022
(86) PCT No.: PCT/CN2022/109368

§ 371 Date: Nov. 21, 2024

(51) Int. Cl. H04L 1/00; H04W 72/1268

(52) U.S. Cl. CPC H04L 1/0003; H04L 1/0009; H04W 72/1268

(57) ABSTRACT

Some techniques described herein provide autonomous modification of a modulation and coding scheme (MCS) of a grant for a transmission by a user equipment UE. For example, the UE may receive a grant (e.g., a configured grant) indicating a resource allocation and a first MCS for a transmission on the resource allocation. The UE may use the resource allocation for a transmission of a number of transport blocks (e.g., one or more transport blocks), and may use a second MCS, different than the first MCS, for the transmission. In some examples, the second MCS may be a lower MCS, associated with a lower modulation scheme and/or code rate, than the first MCS. Thus, a per-resource-block power consumption of the transmission is decreased by using the second MCS, which provides power savings while reducing or eliminating padding of the uplink communication.

### FIELD OF THE DISCLOSURE

Aspects of the present disclosure generally relate to wireless communication and to techniques and apparatuses for modification of a modulation and coding scheme (MCS).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. 5G, which may be referred to as New Radio (NR), is a set of enhancements to the LTE mobile standard promulgated by the 3GPP. 5G is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in 4G, 5G, and other radio access technologies remain useful.

### SUMMARY

A UE may receive a grant indicating a resource allocation (e.g., time resources, frequency resources, spatial resources, or the like) and transmission parameters for an uplink communication of the UE. For example, the grant may be a configured grant (in which a periodic resource allocation is configured for recurring usage by the UE) or a dynamic grant (which is provided via dynamic signaling and grants a specific resource allocation for an uplink communication). A configured grant may be useful for recurring communications, such as for applications involving periodic or quasi-periodic transmissions (e.g., extended reality (XR), which may involve periodic transmissions corresponding to a frame rate of an XR scene, among other examples). However, a configured grant may be configured via semi-static signaling (e.g., radio resource control (RRC) signaling) with transmission parameters, such as a modulation and coding scheme (MCS), that are fixed until modified by further semi-static signaling. As the amount of uplink data to be transmitted by the UE changes, the transmission parameters of the configured grant may become unsuitable for uplink communications of the UE. For example, if the amount of uplink data to be transmitted by the UE decreases over time, the configured grant may over-allocate resources for uplink communication, leading to increased power consumption at the UE, padding of an uplink communication to fill an over-allocated resource allocation.

Some techniques described herein provide modification of an MCS of a grant for a transmission by a UE. For example, the UE may receive a grant (e.g., a configured grant) indicating a resource allocation and a first MCS for a transmission on the resource allocation. The UE may use the resource allocation for a transmission of a number of transport blocks (e.g., one or more transport blocks), and may use a second MCS, different than the first MCS, for the transmission. For example, the UE may switch from the first MCS to the second MCS. In some examples, the second MCS may be a lower MCS, associated with a lower modulation scheme and/or code rate, than the first MCS. Thus, a per-resource-block power consumption of the transmission is decreased by using the second MCS, which provides power savings while reducing or eliminating padding of the uplink communication. Some techniques described herein provide signaling indicating the modification of the MCS of the grant, which reduces resource consumption at a network node (e.g., a base station, a radio unit, a distributed unit, or a central unit) by reducing the complexity of blind decoding at the network node. Some techniques described herein provide configuration or indication of a set of MCSs from which the UE can select the second MCS, or constraints defining the set of MCSs from which the UE can select the second MCS, which also reduces the complexity of blind decoding at the network node.

Some aspects described herein relate to a method of wireless communication performed by a UE. The method may include receiving a grant indicating a first MCS for an uplink communication including a number of resource blocks. The method may include transmitting, without having received signaling modifying the first MCS, the uplink communication on the grant using a second MCS, different than the first MCS, the uplink communication including the number of resource blocks.

Some aspects described herein relate to a method of wireless communication performed by a network node. The method may include outputting a grant indicating a first MCS for an uplink communication including a number of resource blocks. The method may include obtaining, without having outputted signaling modifying the first MCS, the uplink communication using a second MCS, different than the first MCS, and including the number of resource blocks.

Some aspects described herein relate to a UE for wireless communication. The user equipment may include a memory and one or more processors coupled to the memory. The one or more processors may be configured to receive a grant indicating a first MCS for an uplink communication including a number of resource blocks. The one or more processors may be configured to transmit, without having received signaling modifying the first MCS, the uplink communication on the grant using a second MCS, different than the first MCS, the uplink communication including the number of resource blocks.

Some aspects described herein relate to a network node for wireless communication. The network node may include a memory and one or more processors coupled to the memory. The one or more processors may be configured to output a grant indicating a first MCS for an uplink communication including a number of resource blocks. The one or more processors may be configured to obtain, without having outputted signaling modifying the first MCS, the uplink communication using a second MCS, different than the first MCS, and including the number of resource blocks.

Some aspects described herein relate to a non-transitory computer-readable medium that stores a set of instructions for wireless communication by a user equipment (UE). The set of instructions, when executed by one or more processors of the UE, may cause the UE to receive a grant indicating a first MCS for an uplink communication including a number of resource blocks. The set of instructions, when executed by one or more processors of the UE, may cause the UE to transmit, without having received signaling modifying the first MCS, the uplink communication on the grant using a second MCS, different than the first MCS, the uplink communication including the number of resource blocks.

Some aspects described herein relate to a non-transitory computer-readable medium that stores a set of instructions for wireless communication by a network node. The set of instructions, when executed by one or more processors of the network node, may cause the network node to output a grant indicating a first MCS for an uplink communication including a number of resource blocks. The set of instructions, when executed by one or more processors of the network node, may cause the network node to obtain, without having outputted signaling modifying the first MCS, the uplink communication using a second MCS, different than the first MCS, and including the number of resource blocks.

Some aspects described herein relate to an apparatus for wireless communication. The apparatus may include means for receiving a grant indicating a first MCS for an uplink communication including a number of resource blocks. The apparatus may include means for transmitting, without having received signaling modifying the first MCS, the uplink communication on the grant using a second MCS, different than the first MCS, the uplink communication including the number of resource blocks.

Some aspects described herein relate to an apparatus for wireless communication. The apparatus may include means for outputting a grant indicating a first MCS for an uplink communication including a number of resource blocks. The apparatus may include means for obtaining, without having outputted signaling modifying the first MCS, the uplink communication using a second MCS, different than the first MCS, and including the number of resource blocks.

Aspects generally include a method, apparatus, system, computer program product, non-transitory computer-readable medium, user equipment, base station, wireless communication device, network entity, network node, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of uplink configured grant (CG) communication, in accordance with the present disclosure.

FIG. 5 is a diagram illustrating an example of signaling associated with modifying a modulation and coding scheme (MCS) of a grant, in accordance with the present disclosure.

FIG. 6 is a flowchart of an example method of wireless communication.

FIG. 7 is a flowchart of an example method of wireless communication.

FIG. 8 is a diagram of an example apparatus for wireless communication, in accordance with the present disclosure.

FIG. 9 is a diagram of an example apparatus for wireless communication, in accordance with the present disclosure.

FIG. 10 is a diagram illustrating an example of a hardware implementation for an apparatus employing a processing system, in accordance with the present disclosure.

FIG. 11 is a diagram illustrating an example of a hardware implementation for an apparatus employing a processing system, in accordance with the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

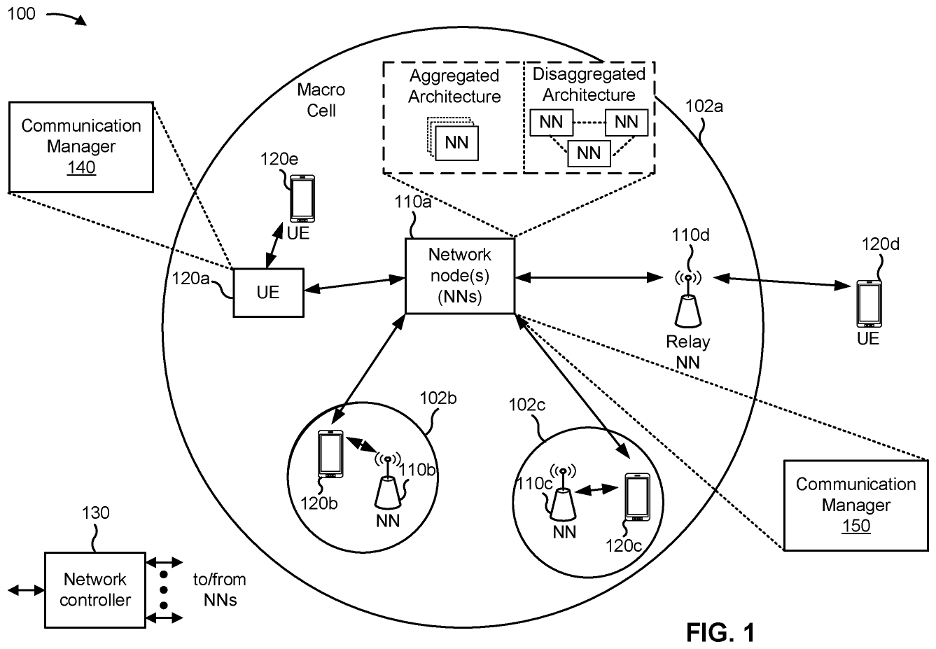

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing 284 that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a grant indicating a first MCS for an uplink communication including a number of resource blocks; and transmit, without having received signaling modifying the first MCS, the uplink communication on the grant using a second MCS, different than the first MCS, the uplink communication including the number of resource blocks. Additionally, or alternatively, the communication manager 140 may perform one or more other operations described herein.

In some aspects, the network node may include a communication manager 150. As described in more detail elsewhere herein, the communication manager 150 may output a grant indicating a first MCS for an uplink communication including a number of resource blocks; and obtain, without having outputted signaling modifying the first MCS, the uplink communication using a second MCS, different than the first MCS, and including the number of resource blocks. Additionally, or alternatively, the communication manager 150 may perform one or more other operations described herein.

As indicated above, FIG. 1 is provided as an example. Other examples may differ from what is described with regard to FIG. 1.

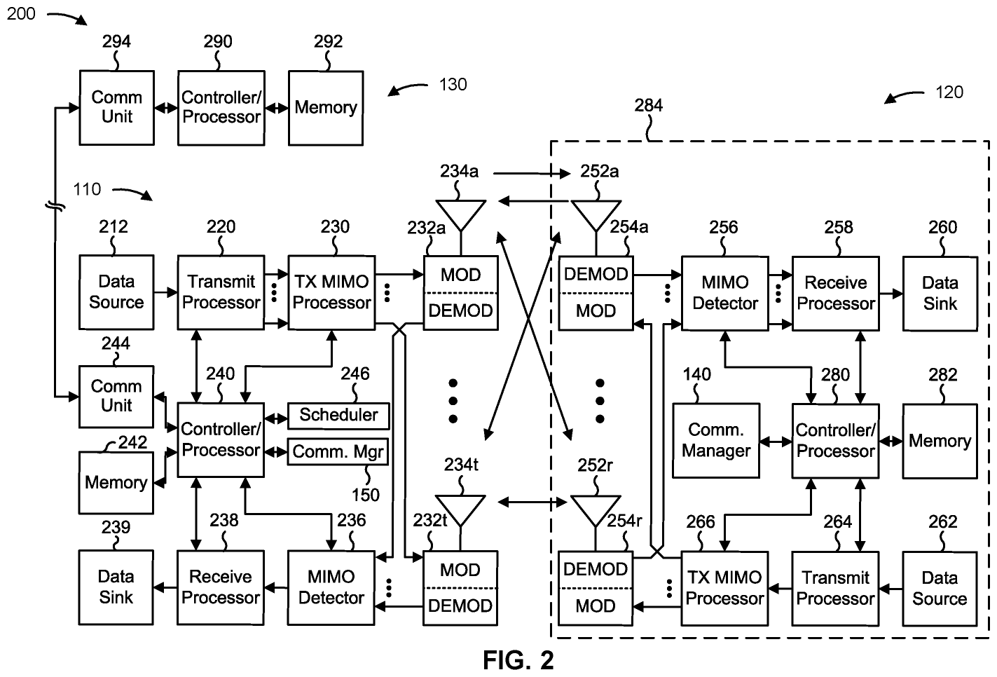

FIG. 2 is a diagram illustrating an example 200 of a network node 110 in communication with a user equipment (UE) 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein.

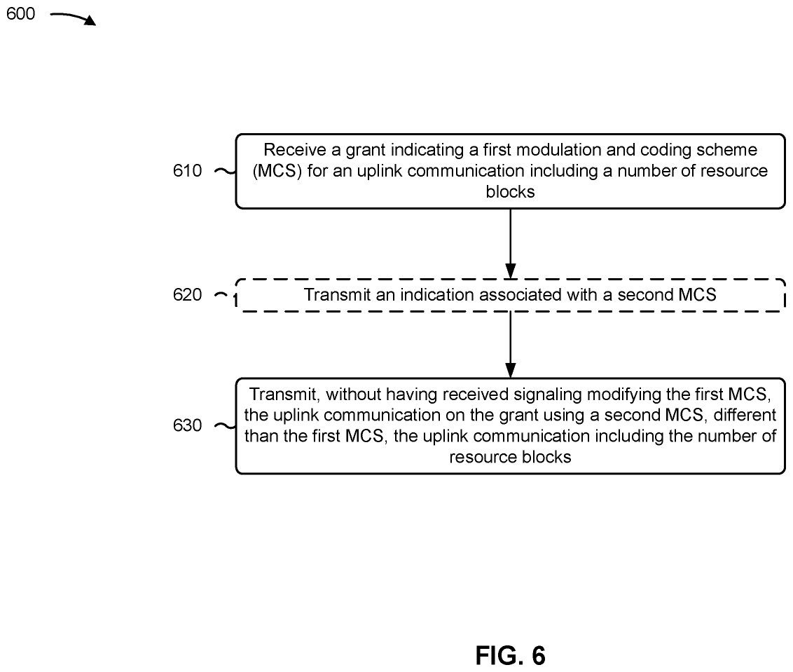

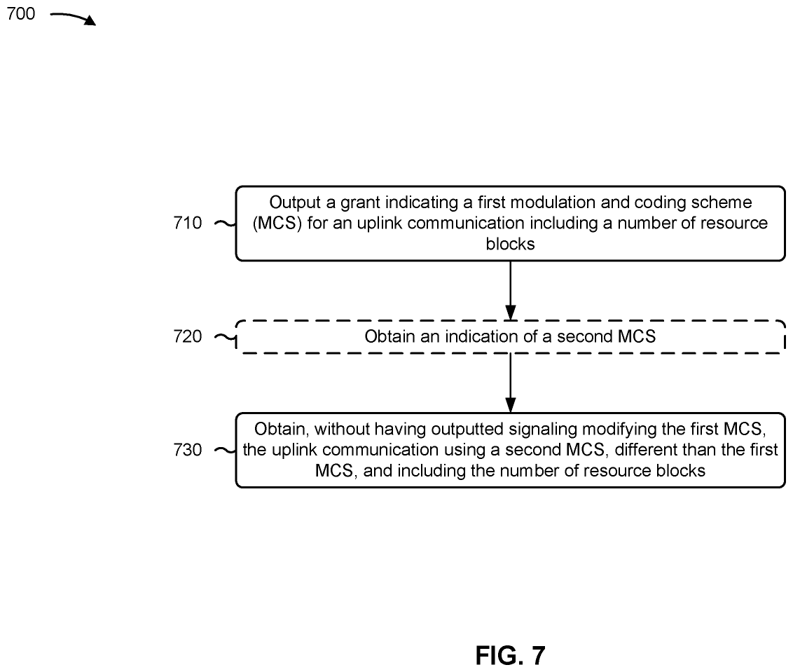

The controller/processor 240 of the network node 110, the controller/processor 280 of the UE 120, and/or any other component(s) of FIG. 2 may perform one or more techniques associated with configured grant communication, as described in more detail elsewhere herein. For example, the controller/processor 240 of the network node 110, the controller/processor 280 of the UE 120, and/or any other component(s) of FIG. 2 may perform or direct operations of, for example, method 600 of FIG. 6, method 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, method 600 of FIG. 6, method 700 of FIG. 7, and/or other processes as described herein. In some examples, executing instructions may include running the instructions, converting the instructions, compiling the instructions, and/or interpreting the instructions, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station (BS), a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

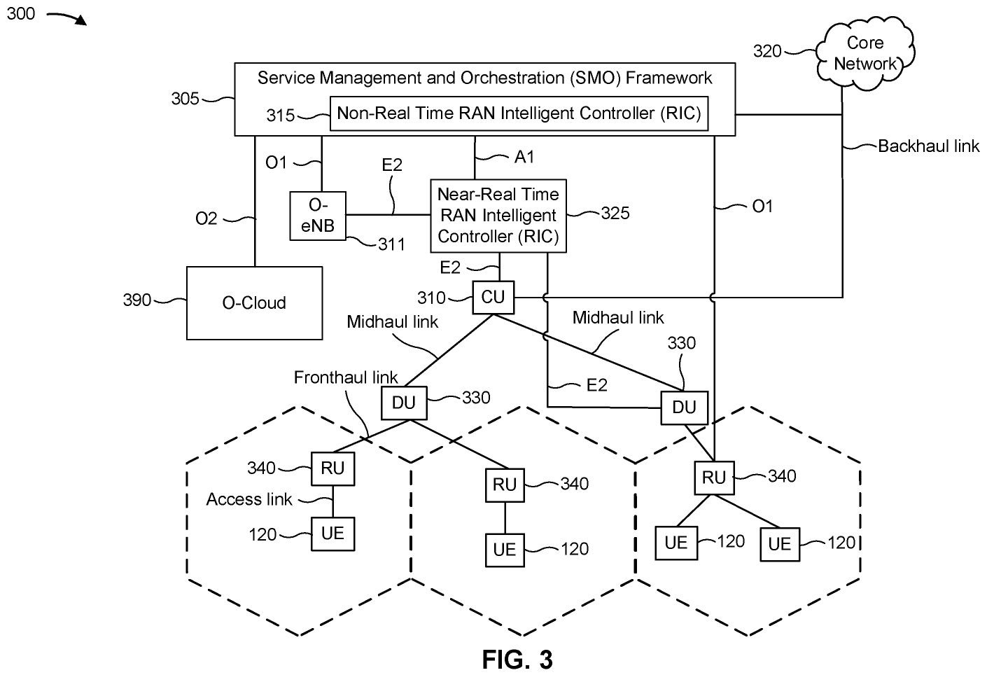

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

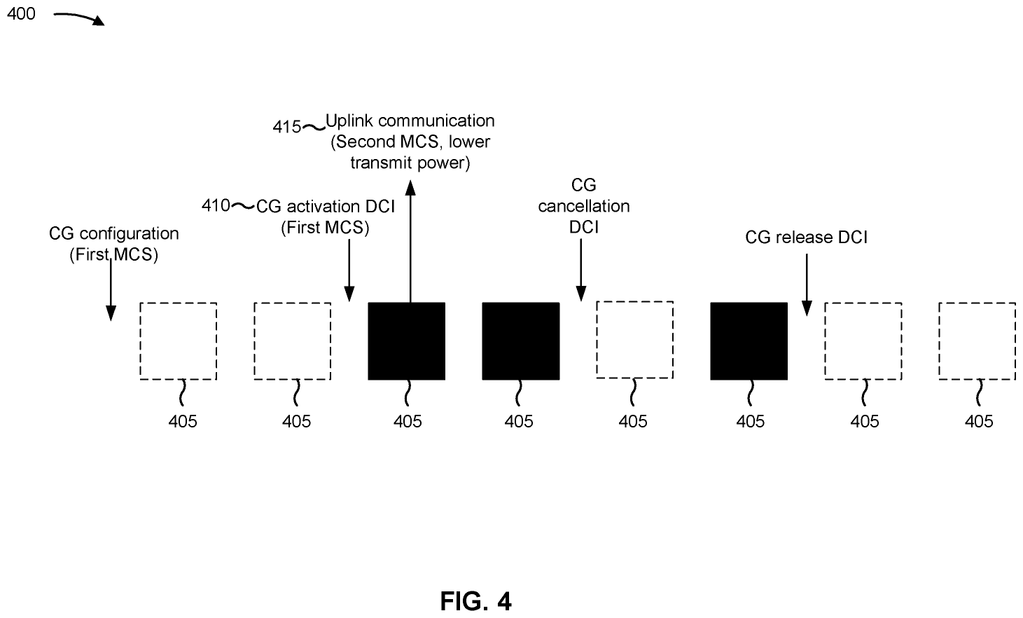

FIG. 4 is a diagram illustrating an example 400 of uplink configured grant (CG) communication, in accordance with the present disclosure. CG communications may include periodic uplink communications that are configured for a UE, such that the base station does not need to send separate downlink control information (DCI) to schedule each uplink communication, thereby conserving signaling overhead.

In one example, CG communication may be useful for XR applications. As the traffic generated by XR application is quasi-periodic, it is suitable to use CG communication for uplink XR video data transmission. When compared to a dynamic grant (DG), CG communication reduces the overhead of a scheduling DCI. Moreover, the UE does not need to transmit a scheduling request (SR), monitor a physical downlink control channel (PDCCH) for an uplink grant, or transmit a buffer status report (BSR) before transmitting uplink data. This reduces latency and allows uplink packet transmission to meet the packet delay budget (PDB), which may be stringent for XR communications. However, the configuration of resource allocation of CG is semi-static via RRC signaling. Even with a Type 2 CG (in which DCI activates a CG configuration, as described with regard to FIG. 4), the DCI is required to activate or modify a CG configuration. Therefore, the CG configuration may have difficultly dynamically adapting to traffic packet sizes such as XR traffic packet sizes.

As shown in example 400, a UE may be configured with a CG configuration for CG communications. For example, the UE may receive the CG configuration via an RRC message transmitted by a base station. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 405 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

As shown by reference number 410, the base station may transmit CG activation DCI to the UE to activate the CG configuration for the UE. The base station may indicate, in the CG activation DCI, transmission parameters, such as an MCS, an RB allocation, and/or antenna ports, for the CG physical uplink shared channel (PUSCH) communications to be transmitted in the scheduled CG occasions 405. The MCS indicated by the CG activation DCI is referred to as a first MCS. The UE may begin transmitting in the CG occasions 405 based at least in part on receiving the CG activation DCI. For example, beginning with a next scheduled CG occasion 405 subsequent to receiving the CG activation DCI, the UE may transmit a PUSCH communication in the scheduled CG occasions 405 using the transmission parameters indicated in the CG activation DCI. The UE may refrain from transmitting in configured CG occasions 405 prior to receiving the CG activation DCI.

In some cases, the communication needs of the UE may change. For example, the UE may have less uplink data to transmit in a later CG occasion 405 than in an earlier CG occasion 405. If the transmission parameters of the CG configuration are held constant across each CG occasion 405, then the UE may consume power and/or pad an uplink communication so that the RB allocation of a corresponding CG occasion 405 is fully utilized. Techniques described herein provide modification of an MCS of a grant, such as a CG. For example, as shown by reference number 415, the UE may transmit an uplink communication (such as a PUSCH communication) using a second MCS different than the first MCS. For example, the UE may switch from the first MCS to the second MCS. In some aspects, the uplink communication shown by reference number 415 may utilize the RB allocation of the CG configuration, and may use a lower MCS (e.g., an MCS associated with a lower modulation scheme, such as QPSK instead of 16QAM, and/or a lower code rate) than the first MCS. In some examples, the lower MCS may decrease power consumption at the UE, such as by providing a lower per-RB transmit power than the first MCS. In some other examples, the uplink communication shown by reference number 415 may be transmitted with a same per-RB transmit power as an uplink communication using the first MCS, which increases reliability of the uplink communication shown by reference number 415. Thus, utilization of communication resources is improved (particularly for uplink communications of variable size such as XR communications) and overhead and power consumption are reduced.

In some cases, such as when the base station needs to override a scheduled CG communication for a higher priority communication, the base station may transmit CG cancellation DCI to the UE to temporarily cancel or deactivate one or more subsequent CG occasions 405 for the UE. The CG cancellation DCI may deactivate only a subsequent one CG occasion 405 or a subsequent N CG occasions 405 (where N is an integer). CG occasions 405 after the one or more (e.g., N) CG occasions 405 subsequent to the CG cancellation DCI may remain activated. Based at least in part on receiving the CG cancellation DCI, the UE may refrain from transmitting in the one or more (e.g., N) CG occasions 405 subsequent to receiving the CG cancellation DCI. As shown in example 400, the CG cancellation DCI cancels one subsequent CG occasion 405 for the UE. After the CG occasion 405 (or N CG occasions) subsequent to receiving the CG cancellation DCI, the UE may automatically resume transmission in the scheduled CG occasions 405.

The base station may transmit CG release DCI to the UE to deactivate the CG configuration for the UE. The UE may stop transmitting in the scheduled CG occasions 405 based at least in part on receiving the CG release DCI. For example, the UE may refrain from transmitting in any scheduled CG occasions 405 until another CG activation DCI is received from the base station. Whereas the CG cancellation DCI may deactivate only a subsequent one CG occasion 405 or a subsequent N CG occasions 405, the CG release DCI deactivates all subsequent CG occasions 405 for a given CG configuration for the UE until the given CG configuration is activated again by a new CG activation DCI.

As indicated above, FIG. 4 is provided as an example. Other examples may differ from what is described with respect to FIG. 4.

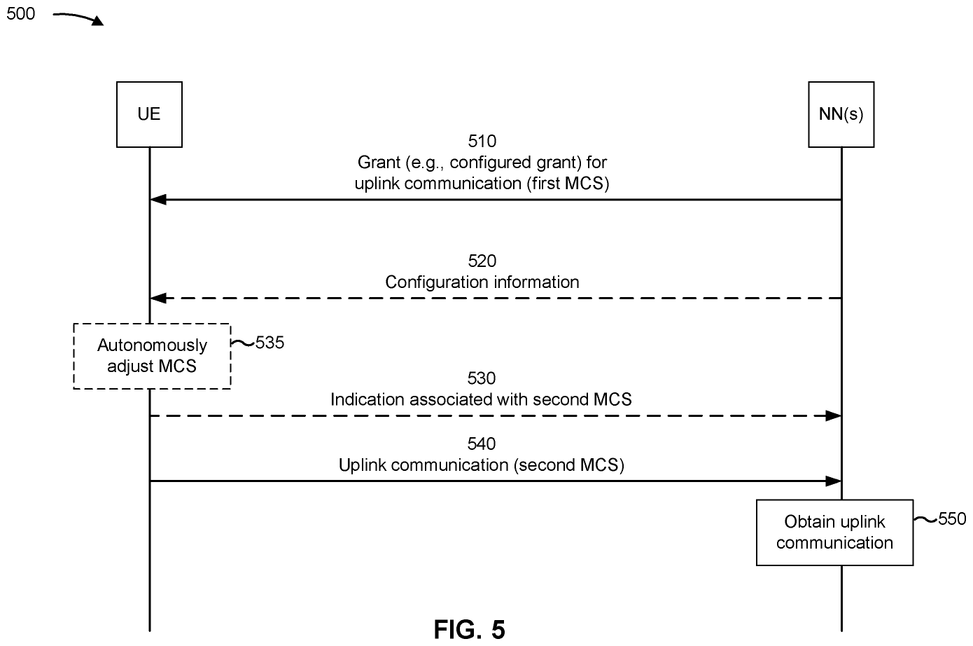

FIG. 5 is a diagram illustrating an example 500 of signaling associated with modifying an MCS of a grant, in accordance with the present disclosure. As shown, example 500 includes a UE (e.g., UE 120) and a network node (e.g., one or more network nodes 110). In some aspects, the network node may include multiple network nodes, such as one or more RUs, one or more DUs, one or more CUs, or a combination thereof. Operations described herein as performed by the network node may be performed by one or more network nodes included in or associated with the network node according to a functional split as described elsewhere herein. For example, configuration operations (e.g., RRC signaling) may be performed by a CU or a DU. As another example, communication operations (e.g., radio communication, transmission and reception of physical channels) may be performed by an RU.

In example 500, the UE reduces an MCS of a grant, such as a CG configuration, by switching from the MCS of the grant to a second MCS. In some aspects, the MCS is reduced to fit an available payload (e.g., of an uplink communication of the UE) while keeping the number of RBs of the uplink communication the same. In some aspects, the UE may reduce a per-RB transmit power based at least in part on the lower MCS. For example, the UE may reduce the MCS such that the available payload occupies the number of RBs of the CG configuration without padding (e.g., unnecessary padding) of the PUSCH communication carrying the payload. In some aspects, the UE may reduce the MCS for first hybrid automatic repeat request (HARQ) transmissions, and not for repetitions of the first HARQ transmission (for example, the UE may switch between an MCS of the grant and a reduced MCS), which avoids an issue where the network node is not able to combine two HARQ transmissions of different MCSs.

As shown by reference number 510, the network node (e.g., a CU or DU of the network node) may output a grant. For example, the network node may provide the grant for transmission by another network node. As another example, the network node may transmit the grant. The UE may receive the grant. For example, the network node may transmit a CG configuration indicating a configured grant. The grant may identify a first MCS and a resource allocation (e.g., a periodic resource allocation, corresponding to a set of CG occasions) for uplink communications of the UE. In some aspects, the grant may indicate multiple MCSs (e.g., the first MCS and the second MCSs with which the uplink communication is transmitted at reference number 540). For example, the grant may include a field (e.g., a single field) indicating the multiple MCSs. As another example, the grant may include a plurality of MCS fields, and each MCS field of the plurality of MCS fields may indicate a different MCS selectable by the UE for the uplink communication. In some aspects, the CG configuration, or an uplink communication associated with the CG configuration, may be associated with an XR application. For example, a traffic type of the uplink communication may be associated with an XR application. As another example, the CG configuration may be configured based at least in part on the XR application (e.g., a periodicity of CG occasions may align with a frame rate or a periodicity of uplink communications of the XR application). In some aspects, the grant may be a dynamic grant scheduling a resource for the uplink communication.

An MCS is a parameter indicating a modulation order (e.g., binary phase shift keying (BPSK), quadrature phase shift keying (QPSK), X-quadrature amplitude modulation (X-QAM), or the like) and a code rate. A modulation order indicates how many bits can be modulated into a symbol. A code rate indicates a ratio of useful bits (e.g., information bits) to total transmitted bits. A first MCS can be higher than a second MCS or lower than a second MCS. In some aspects, a first MCS is considered higher than a second MCS if the first MCS has a higher spectral efficiency (defined as the product of the number of bits associated with the modulation order and the code rate) than the second MCS. In some aspects, a first MCS is considered higher than a second MCS if the first MCS has a higher index (as identified by an MCS table of a wireless communication specification) than the second MCS. A communication using a particular MCS is modulated using a modulation order associated with the MCS and encoded using a code rate associated with the MCS.

As shown by reference number 520, in some aspects, the network node may output configuration information. For example, the network node may provide the configuration information for transmission by another network node. As another example, the network node may transmit the configuration information. The configuration information may include, for example, RRC signaling. For example, the configuration information may include one or more RRC messages, one or more RRC parameters, or the like. In some aspects, the configuration information may include medium access control (MAC) signaling, such as a MAC control element (MAC-CE). In some aspects, the configuration information may include DCI. In some aspects, the configuration information may include the grant (e.g., the CG configuration) described with regard to reference number 510.

In some aspects, the configuration information may include a CG configuration associated with uplink control information (UCI). For example, the UE may transmit UCI including an indication of a modification to an MCS. The configuration information may include a CG configuration of a CG on which the UCI can be transmitted. In some aspects, the CG configuration may have a periodicity such that CG occasions of the CG (associated with the UCI) occur prior to CG occasions of the grant of reference number 510. For example, a CG occasion of the CG associated with the UCI may occur before each CG occasion, for PUSCH transmission, of the grant described with regard to reference number 510. In some aspects, the configuration information may indicate a time offset relative to DCI activating the CG configuration associated with UCI. For example, the time offset may be between a time at which the DCI is received, and a time of a first CG occasion of the CG configuration.

In some aspects, the configuration information may indicate a step size associated with a differential change of an MCS. For example, the UE may increase or decrease its MCS in accordance with the step size. In some aspects, the configuration information (e.g., DCI, a MAC-CE, RRC signaling) may indicate the step size. In some aspects, the configuration information may indicate that indication of the differential change of the MCS, in accordance with the step size, is activated. Thus, the UE can differentially change the MCS, such as by increasing the MCS in accordance with the step size and/or decreasing the MCS in accordance with the step size. In some aspects, the UE may continually adjust the MCS. For example, the UE may, over the course of multiple CG occasions, increase or decrease the MCS iteratively (e.g., in accordance with the step size). The continual adjustment may be based at least in part on, for example, an amount of uplink data to be transmitted, a power control parameter, or the like. In some aspects, the UE may increase the MCS multiple times (e.g., consecutively). In some aspects, the UE may decrease the MCS multiple times (e.g., consecutively).

In some aspects, the UE may adjust the MCS based at least in part on a time threshold. For example, after adjusting the MCS, the UE may wait for at least a length of the time threshold before adjusting the MCS again. Thus, the time threshold may identify a minimum length of time between adjustments of the MCS, which reduces blind decoding complexity at the network node.

In some aspects, the configuration information may indicate a power control parameter (e.g., a power control command). For example, the configuration information may indicate a power control parameter used to determine an uplink transmit power of the UE, or may indicate to increment or decrement a power control parameter in accordance with a power control command. In some aspects, the power control parameter may be associated with a modified MCS. For example, the UE may use the power control parameter if the UE transmits an uplink communication using a modified MCS, as described with regard to reference number 540. If the UE then modifies the MCS again (such as to return to an original MCS), the UE may use a different power control parameter, such as a power control parameter associated with the newly modified MCS.

In some aspects, the configuration information may indicate a set of MCSs from which the UE can select a modified MCS (modified relative to the first MCS). In some aspects, configuration information (e.g., RRC signaling, system information, or the like) may indicate multiple sets of MCSs, and the UE may receive an indication (e.g., via RRC signaling, MAC signaling, DCI, or the like) of which set of MCSs, of the multiple sets of MCSs, is to be used. In some aspects, multiple sets of MCSs may be specified in a wireless communication specification, and the UE may receive an indication (e.g., via RRC signaling, MAC signaling, DCI, or the like) of which set of MCSs, of the multiple sets of MCSs, is to be used. The set of MCSs may include one or more MCSs. In some aspects, the set of MCSs may be a proper subset of MCSs that can be indicated by the grant of reference number 510. In some aspects, the configuration information may explicitly identify the one or more MCSs (such as using one or more MCS indexes defined in a wireless communication specification). In some aspects, the configuration information may identify a range of MCSs. For example, the configuration information may indicate a number of MCSs included in the set of MCSs. In some aspects, the set of MCSs may include the first MCS (indicated by the grant) and a number of MCSs (e.g., N−1 MCSs) associated with lower MCS indexes than the first MCS, where the configuration information indicates the number of MCSs (e.g., N). The UE may adjust its MCS by selecting an MCS, of the set of MCSs, for an uplink transmission. Additionally, or alternatively, the UE may continually adjust the MCS, such as by selecting, at different times, different MCSs of the set of MCSs for different uplink transmissions.

As shown by reference number 530, in some aspects, the UE may transmit an indication associated with a second MCS. For example, the UE may transmit an indication of the second MCS (e.g., the indication may identify an MCS index of the second MCS). The second MCS is an MCS used by the UE to transmit an uplink communication shown on resources granted by the grant shown by reference number 510. As used herein, “transmitting an uplink communication on a grant” is synonymous with “transmitting an uplink communication on resources granted by the grant.” The second MCS may be different than the first MCS (e.g., may be lower than the first MCS or may be higher than the second MCS). In some aspects, the indication may be or may be included in UCI transmitted by the UE. For example, the UE may transmit the UCI on an uplink control channel resource (e.g., a physical uplink control channel (PUCCH) resource) in a same slot as an uplink communication (shown by reference number 540) on the grant shown by reference number 510. As another example, the UE may transmit the UCI on one or more resource elements (REs) (e.g., one or more reserved REs) of a PUSCH (such as a PUSCH transmitted on resources of the grant of reference number 510, or a PUSCH scheduled separately from the grant). In such examples, the one or more REs may use a predefined MCS such that there is no ambiguity at the network node with regard to how to receive the PUSCH. For example, the predefined MCS may be indicated by the grant shown by reference number 510, may be indicated by scheduling information for the PUSCH, may be indicated by the configuration information shown by reference number 520, or may be defined in a wireless communication specification. In some aspects, the UE may transmit UCI indicating an updated MCS each time the UE switches the MCS. For example, as the UE continually adjusts the MCS, the UE may provide UCI indicating the updated MCS or indicating the adjustment to the MCS.

In some aspects, as shown by reference number 535, the UE may autonomously adjust (e.g., switch) the first MCS. For example, the UE may switch from the first MCS to the second MCS. As another example, the UE may select the second MCS from a set of MCSs selectable by the UE. In some aspects, the UE may select the second MCS autonomously. For example, the UE may select the second MCS without receiving signaling (e.g., DCI or other information) from the network node or another network node instructing the UE to use the second MCS. In some aspects, the UE may continually adjust the MCS. For example, the UE may adjust the MCS of the uplink grant multiple times without receiving explicit signaling updating the MCS. Thus, the UE can adjust the MCS of uplink communications of the grant (e.g., the CG configuration) without explicit signaling from the network node, thereby reducing overhead and improving resource utilization of the grant.

In some aspects, the indication may indicate a differential change from the first MCS to the second MCS. For example, the indication may indicate whether the first MCS is increased or decreased, and the UE and the network node may determine the second MCS based at least in part on the indication and a step size associated with the differential change. For example, if the step size is configured as “2,” the first MCS has an MCS index of 20, and the indication indicates a decreased MCS, the UE may transmit the uplink communication, and the network node may receive the uplink communication, using a second MCS with an MCS index of 18. In some aspects, the indication may indicate a magnitude of the differential change. For example, the indication may indicate a number of steps (based on the step size) between an MCS index of the first MCS and an MCS index of the second MCS. As another example, the indication may explicitly identify a difference in an MCS index of the first MCS and an MCS index of the second MCS.

In some aspects, the indication may indicate a differential change relative to a reference MCS. In some aspects, a reference MCS may be a default MCS (e.g., the first MCS, an MCS specified by a wireless communication specification, or the like). In some aspects, the indication may indicate a differential change relative to the first MCS indicated by the grant shown by reference number 510.

In some aspects, the indication may indicate a modification to a transmission parameter of the uplink communication. The transmission parameter may be modified relative to a transmission parameter identified by the grant shown by reference number 510. For example, the indication may indicate a transmission parameter of the second MCS. As another example, the indication may indicate a transmission parameter of modified number of RBs for the uplink communication. As yet another example, the indication may indicate a transmission parameter of a modified number of layers of the uplink communication. In some aspects, the UCI may be an acknowledgment (ACK) or negative ACK regarding an uplink DCI message (such as an uplink DCI message carrying one or more transmission parameters). For example, the UCI can indicate to increase the MCS by X or decrease the MCS by Y. As another example, an ACK may indicate that the uplink transmission of reference number 540 is to use the same MCS indicated by the grant shown by reference number 510, and a NACK may indicate to use a lower MCS with MCS index MCS_def−Y, where MCS_def is a default MCS and a value of Y is configured via DCI, a MAC-CE, or RRC signaling.

As shown by reference number 540, the UE may transmit an uplink communication using the second MCS. The uplink communication may include a number of RBs indicated by the grant shown by reference number 510. For example, the UE may modify an MCS of the uplink communication without modifying a number of RBs transmitted in the uplink communication. The UE may transmit the uplink communication on a CG occasion of the CG configuration of reference number 510. In some aspects, the UE may transmit the uplink communication using the second MCS based at least in part on an amount of uplink data to be transmitted in the uplink communication. For example, if the amount of uplink data is lower than a threshold, the UE may transmit the uplink communication using the second MCS. If the amount of uplink data is greater than or equal to the threshold, the UE may transmit the uplink communication using the first MCS. Thus, the UE may reduce power consumption when the amount of uplink data is low by decreasing the MCS. In some aspects, the UE may transmit multiple uplink communications in accordance with the grant, and the UE may iteratively (e.g., continually) adjust the MCS for each of the multiple uplink communications.

The UE may transmit the uplink communication with a transmit power per RB (sometimes referred to as a per-RB transmit power). The transmit power per RB may be based at least in part on the MCS used to transmit the uplink communication. For example, if the second MCS (used to transmit the uplink communication) is lower than the first MCS, the uplink communication may have a lower transmit power per RB than if the uplink communication were transmitted with the first MCS. In some aspects, the transmit power of the uplink communication is based at least in part on the configuration information shown by reference number 520. For example, the configuration information may indicate a transmit power parameter used to determine a transmit power for uplink communications associated with a modified MCS (e.g., the second MCS). As another example, the configuration information may indicate a power offset, relative to a baseline transmit power, for the uplink communication. In some aspects, the indication of reference number 530 may include information relating to the transmit power for the uplink communication. For example, the indication may indicate a transmit power for the uplink communication, may indicate a selected transmit power out of multiple transmit powers configured by the configuration information, or the like. Thus, flexibility of uplink power control is increased, and the uplink transmit power can be decreased even lower than a transmit power associated with the second MCS, thereby further conserving power of the UE.

As shown by reference number 550, the network node may obtain the uplink communication. For example, the network node may receive a PUSCH transmission carrying the uplink communication. As another example, the network node may receive the uplink communication from another network node that received a PUSCH transmission carrying the uplink communication (such as an RU).

In some aspects, obtaining the uplink communication may include performing blind decoding. For example, the network node may perform blind decoding using a plurality of hypotheses. A hypothesis may correspond to an MCS. For example, the network node may perform blind decoding using a plurality of hypotheses, where each hypothesis uses a different MCS of a set of MCSs usable by the UE to transmit the uplink communication. In some aspects, the set of MCSs may be configured by the configuration information shown by reference number 520, or may be indicated to the UE. In some aspects, the set of MCSs may be indicated by the grant of reference number 510. In some aspects, the set of MCSs may be indicated in a wireless communication specification (such as a proper subset of MCSs indicatable by a grant). By performing blind decoding based at least in part on the subset of MCSs, the network node may reduce reception resource consumption and latency relative to performing blind decoding using hypotheses corresponding to all usable MCSs.

As indicated above, FIG. 5 is provided as an example. Other examples may differ from what is described with regard to FIG. 5.

FIG. 6 is a flowchart of an example method 600 of wireless communication. The method 600 may be performed by, for example, a user equipment (UE) (e.g., UE 120).

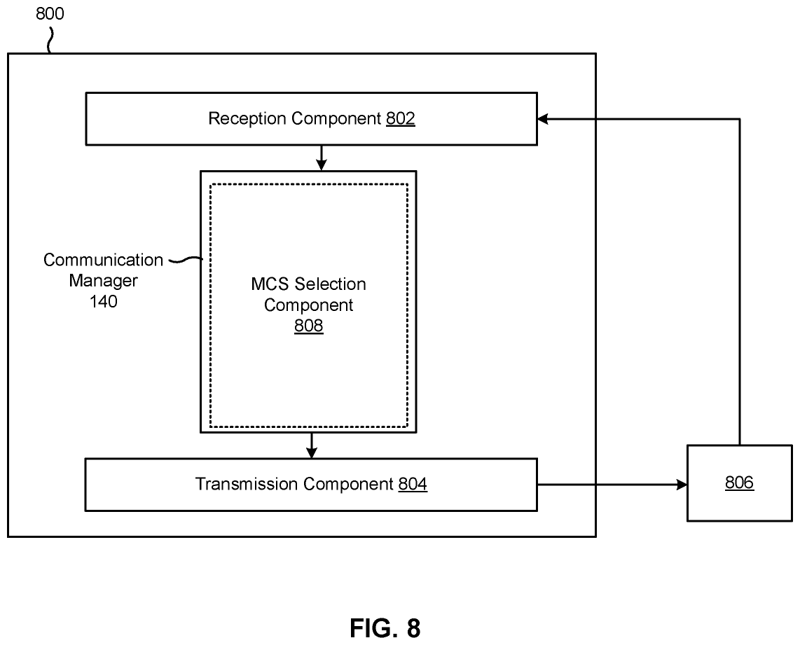

At 610, the UE may receive a grant indicating a first MCS for an uplink communication including a number of resource blocks. For example, the UE (e.g., using communication manager 140 and/or reception component 802, depicted in FIG. 8) may receive a grant indicating a first MCS for an uplink communication including a number of resource blocks, as described above in connection with, for example, FIG. 5 and at 510.

At 620, the UE may optionally transmit an indication associated with a second MCS. For example, the UE (e.g., using communication manager 140 and/or transmission component 804, depicted in FIG. 8) may transmit an indication of a second MCS, as described above in connection with, for example, FIG. 5 and at 530. In some aspects, method 600 includes autonomously adjusting the first MCS to the second MCS prior to transmitting the uplink communication. In some aspects, the first MCS is associated with a first modulation scheme and a first code rate, wherein the second MCS is associated with a second modulation scheme and a second code rate, and wherein the first modulation scheme is higher than the second modulation scheme, or the first code rate is higher than the second code rate.

In some aspects, the indication is transmitted on an uplink control channel resource in a same slot as the uplink communication. In some aspects, the indication is transmitted on one or more resource elements of an uplink shared channel on which the uplink communication is transmitted. In some aspects, the one or more resource elements use the first MCS. In some aspects, the indication indicates a differential change from the first MCS to the second MCS. In some aspects, method 600 includes receiving, prior to transmitting the indication, a configuration of a step size of the differential change. In some aspects, the indication indicates a modification to a number of layers of the uplink communication. In some aspects, the indication is transmitted on a resource granted by a configured grant. In some aspects, the indication indicates a power control parameter associated with a transmit power of the uplink communication.

In some aspects, the grant indicates the first MCS and the second MCS. In some aspects, DCI activating a CG configuration that configures the grant indicates the first MCS and the second MCS. In some aspects, the grant includes a first field indicating the first MCS and a second field indicating the second MCS. In some aspects, DCI activating a CG configuration that configures the grant includes the first field indicating the first MCS and the second field indicating the second MCS. In some aspects, the grant includes a field indicating the first MCS and the second MCS. In some aspects, DCI activating a CG configuration that configures the grant includes the field indicating the first MCS and the second MCS.

At 630, the UE may transmit, without having received signaling modifying the first MCS, the uplink communication on the grant (e.g., resources granted or configured by the grant, such as a CG occasion indicated by a CG configuration that configures the grant) using a second MCS, different than the first MCS, the uplink communication including the number of resource blocks. For example, the UE (e.g., using communication manager 140 and/or transmission component 804, depicted in FIG. 8) may transmit, without having received signaling modifying the first MCS, the uplink communication on the grant using a second MCS, different than the first MCS, the uplink communication including the number of resource blocks, as described above in connection with, for example, FIG. 5 and at 540. In some aspects, the uplink communication is transmitted with a first transmit power per resource block, wherein the first transmit power per resource block is lower than a second transmit power per resource block associated with the first MCS.

In some aspects, the uplink communication is a first uplink communication, and wherein the method further comprises transmitting, without having received signaling modifying the first MCS or the second MCS, a second uplink communication in accordance with the grant using a third MCS. Thus, the UE may continually adjust the MCS of the grant (such as in accordance with a time threshold).

In some aspects, the first MCS and the second MCS are selected from a set of MCSs configured by a network node (e.g., a set of configured MCSs) or specified in a wireless communication specification. In some aspects, the set of MCSs is a proper subset of MCSs that can be indicated by the CG configuration. In some aspects, the second MCS is selected from a set of MCSs including the first MCS and a number of MCSs with lower MCS indexes than the first MCS. In some aspects, the number of MCSs is configured. In some aspects, alone or in combination with one or more of the first through twentieth aspects, the uplink communication is associated with an extended reality (XR) application.

Although FIG. 6 shows example blocks of method 600, in some aspects, method 600 may include additional blocks, fewer blocks, different blocks, or differently arranged blocks than those depicted in FIG. 6. Additionally, or alternatively, two or more of the blocks of method 600 may be performed in parallel.

FIG. 7 is a flowchart of an example method 700 of wireless communication. The method 700 may be performed by, for example, a network node (e.g., network node 110).

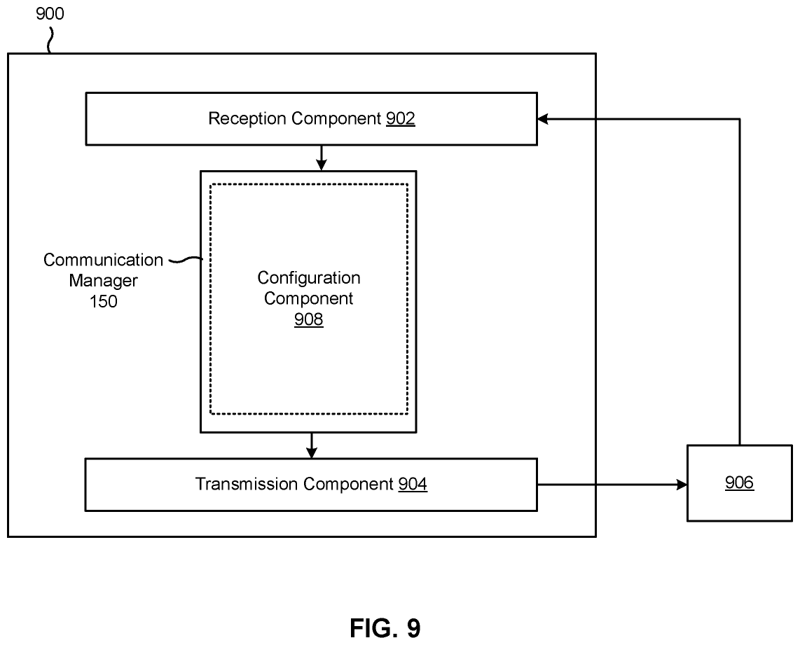

At 710, the network node may output a grant indicating a first MCS for an uplink communication including a number of resource blocks. For example, the network node (e.g., using communication manager 150 and/or configuration component 908, depicted in FIG. 9) may output a grant indicating a first MCS for an uplink communication including a number of resource blocks, as described above in connection with, for example, FIG. 5 and at 510.

At 720, the network node may optionally obtain an indication associated with a second MCS. For example, the network node (e.g., using communication manager 140 and/or reception component 902, depicted in FIG. 9) may obtain (e.g., directly from the UE or via one or more network nodes) an indication of a second MCS, as described above in connection with, for example, FIG. 5 and at 530. In some aspects, the indication is received on an uplink control channel resource in a same slot as the uplink communication. In some aspects, the indication is received on one or more resource elements of an uplink shared channel on which the uplink communication is transmitted. In some aspects, the one or more resource elements use the first MCS. In some aspects, the indication indicates a differential change from the first MCS to the second MCS. In some aspects, method 700 includes outputting, prior to transmitting the indication, a configuration of a step size of the differential change. In some aspects, the indication indicates a modification to a number of layers of the uplink communication. In some aspects, the indication is received on a resource granted by a configured grant. In some aspects, the indication indicates a power control parameter associated with a transmit power of the uplink communication, wherein obtaining the uplink communication is based at least in part on the power control parameter.

At 730, the network node may obtain, without having outputted signaling modifying the first MCS, the uplink communication using a second MCS, different than the first MCS, and including the number of resource blocks. For example, the network node (e.g., using communication manager 150 and/or reception component 902, depicted in FIG. 9) may obtain, without having outputted signaling modifying the first MCS, the uplink communication using a second MCS, different than the first MCS, and including the number of resource blocks, as described above in connection with, for example, FIG. 5 and at 550. In some aspects, obtaining the uplink communication further comprises performing blind decoding based on at least the second MCS. In some aspects, the first MCS is associated with a first modulation scheme and a first code rate, wherein the second MCS is associated with a second modulation scheme and a second code rate, and wherein the first modulation scheme is higher than the second modulation scheme, or the first code rate is higher than the second code rate.

In some aspects, the grant indicates the first MCS and the second MCS. In some aspects, the grant includes a first field indicating the first MCS and a second field indicating the second MCS. In some aspects, the grant includes a field indicating the first MCS and the second MCS. In some aspects, method 700 includes configuring a set of MCSs from which the first MCS and the second MCS are selected. In some aspects, the set of MCSs is a proper subset of MCSs that can be indicated by the grant. In some aspects, the second MCS is from a set of MCSs including the first MCS and a number of MCSs with lower MCS indexes than the first MCS. In some aspects, method 700 includes transmitting configuration information indicating the number of MCSs.

Although FIG. 7 shows example blocks of method 700, in some aspects, method 700 may include additional blocks, fewer blocks, different blocks, or differently arranged blocks than those depicted in FIG. 7. Additionally, or alternatively, two or more of the blocks of method 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of an MCS selection component 808, among other examples.

In some aspects, the apparatus 800 may be configured to perform one or more operations described herein in connection with FIGS. 4 and 5. Additionally, or alternatively, the apparatus 800 may be configured to perform one or more processes described herein, such as method 600 of FIG. 6, method 700 of FIG. 7, or a combination thereof. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive a grant indicating a first modulation and coding scheme (MCS) for an uplink communication including a number of resource blocks. The transmission component 804 may transmit, without having received signaling modifying the first MCS, the uplink communication on the grant (e.g., a CG occasion of a CG configuration) using a second MCS, different than the first MCS, the uplink communication including the number of resource blocks.

The MCS selection component 808 may autonomously adjust the first MCS to the second MCS prior to transmitting the uplink communication. The transmission component 804 may transmit an indication of the second MCS. The reception component 802 may receive, prior to transmitting the indication, a configuration of a step size of the differential change.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of a configuration component 908, among other examples.

In some aspects, the apparatus 900 may be configured to perform one or more operations described herein in connection with FIGS. 4 and 5. Additionally, or alternatively, the apparatus 900 may be configured to perform one or more processes described herein, such as method 600 of FIG. 6, method 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver. In some aspects, the reception component 902 and/or the transmission component 904 may communicate via a transceiver (e.g., transceiver 1130). Additionally, or alternatively, the reception component 902 and/or the transmission component 904 may communicate via a network interface (e.g., network interface 1140).

The transmission component 904 may output a grant indicating a first modulation and coding scheme (MCS) for an uplink communication including a number of resource blocks. The reception component 902 may obtain, without having outputted signaling modifying the first MCS, the uplink communication using a second MCS, different than the first MCS, and including the number of resource blocks.

The reception component 902 may obtain an indication of the second MCS.

The configuration component 908 may output, prior to transmitting the indication, a configuration of a step size of the differential change.

The configuration component 908 may configure a set of MCSs from which the first MCS and the second MCS are selected.

The transmission component 904 may transmit configuration information indicating the number of MCSs.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

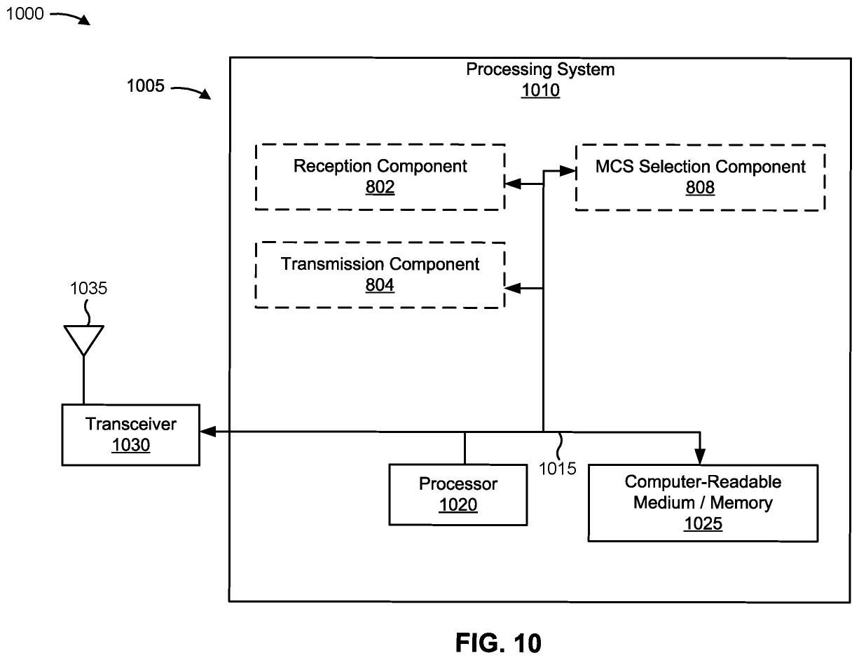

FIG. 10 is a diagram illustrating an example 1000 of a hardware implementation for an apparatus 1005 employing a processing system 1010, in accordance with the present disclosure. The apparatus 1005 may be a UE.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor 1020, the illustrated components, and the computer-readable medium/memory 1025. The bus 1015 may also link various other circuits, such as timing sources, peripherals, voltage regulators, and/or power management circuits.

The processing system 1010 may be coupled to a transceiver 1030. The transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 802. In addition, the transceiver 1030 receives information from the processing system 1010, specifically the transmission component 804, and generates a signal to be applied to the one or more antennas 1035 based at least in part on the received information.

The processing system 1010 includes a processor 1020 coupled to a computer-readable medium/memory 1025. The processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the UE 120 and may include the memory 282 and/or at least one of the TX MIMO processor 266, the RX processor 258, and/or the controller/processor 280. In some aspects, the apparatus 1005 for wireless communication includes means for receiving a configured grant (CG) configuration indicating a first modulation and coding scheme (MCS) for an uplink communication including a number of resource blocks, means for transmitting, without having received signaling modifying the first MCS, the uplink communication on a CG occasion of the CG configuration using a second MCS, different than the first MCS, the uplink communication including the number of resource blocks, or the like. The aforementioned means may be one or more of the aforementioned components of the apparatus 800 and/or the processing system 1010 of the apparatus 1005 configured to perform the functions recited by the aforementioned means. As described elsewhere herein, the processing system 1010 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 10 is provided as an example. Other examples may differ from what is described in connection with FIG. 10.

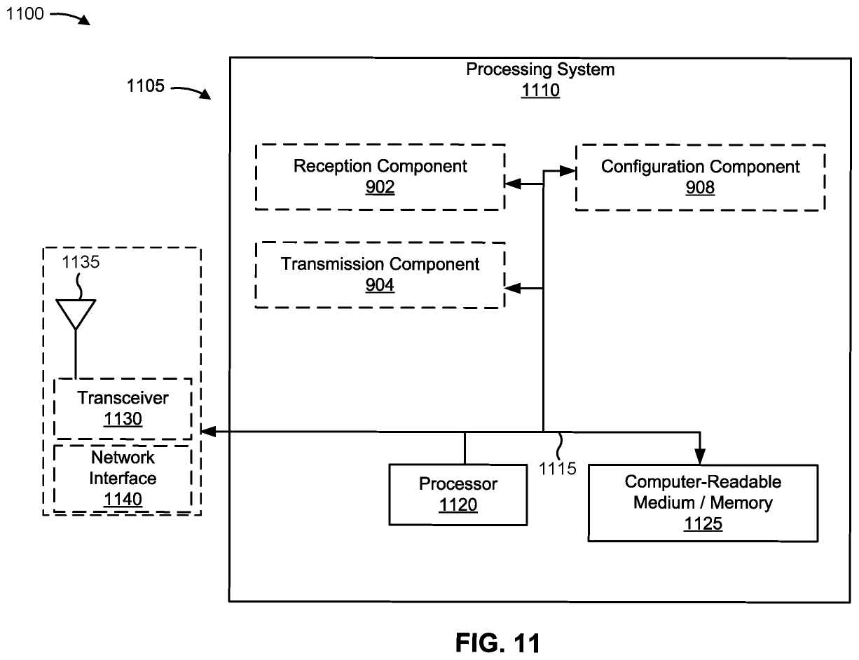

FIG. 11 is a diagram illustrating an example 1100 of a hardware implementation for an apparatus 1105 employing a processing system 1110, in accordance with the present disclosure. The apparatus 1105 may be a network node.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120, the illustrated components, and the computer-readable medium/memory 1125. The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 902. In addition, the transceiver 1130 receives information from the processing system 1110, specifically the transmission component 904, and generates a signal to be applied to the one or more antennas 1135 based at least in part on the received information. In some examples, the processing system 1110 may be coupled to a network interface 1140. The network interface 1140 is configured to obtain and send signals for the apparatus 1105 via communications link(s), such as a backhaul link, midhaul link, and/or fronthaul link as described herein, such as with respect to FIG. 3. The network interface 1140 provides a means for communicating with various other apparatuses (e.g., outputting and/or obtaining information) over one or more communications links.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the network node 110 and may include the memory 242 and/or at least one of the TX MIMO processor 230, the RX processor 238, and/or the controller/processor 240. In some aspects, the apparatus 1105 for wireless communication includes means for means for outputting a CG configuration indicating a first MCS for an uplink communication including a number of resource blocks, means for obtaining, without having outputted signaling modifying the first MCS, the uplink communication using a second MCS, different than the first MCS, and including the number of resource blocks. The aforementioned means may be one or more of the aforementioned components of the apparatus 900 and/or the processing system 1110 of the apparatus 1105 configured to perform the functions recited by the aforementioned means. As described elsewhere herein, the processing system 1110 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 11 is provided as an example. Other examples may differ from what is described in connection with FIG. 11.

The following provides an overview of some Aspects of the present disclosure:

Aspect 1: A method of wireless communication performed by a user equipment (UE), comprising: receiving a grant indicating a first modulation and coding scheme (MCS) for an uplink communication including a number of resource blocks; and transmitting, without having received signaling modifying the first MCS, the uplink communication in accordance with the grant using a second MCS, different than the first MCS, the uplink communication including the number of resource blocks.

Aspect 2: The method of Aspect 1, further comprising autonomously adjusting the first MCS to the second MCS prior to transmitting the uplink communication.

Aspect 3: The method of any of Aspects 1-2, wherein the first MCS is associated with a first modulation scheme and a first code rate, wherein the second MCS is associated with a second modulation scheme and a second code rate, and wherein: the first modulation scheme is higher than the second modulation scheme, or the first code rate is higher than the second code rate.

Aspect 4: The method of any of Aspects 1-3, wherein the uplink communication is transmitted with a first transmit power per resource block, wherein the first transmit power per resource block is lower than a second transmit power per resource block associated with the first MCS.

Aspect 5: The method of any of Aspects 1-4, further comprising: transmitting an indication of the second MCS.

Aspect 6: The method of Aspect 5, wherein the indication is transmitted on an uplink control channel resource in a same slot as the uplink communication.

Aspect 7: The method of Aspect 5, wherein the indication is transmitted on one or more resource elements of an uplink shared channel on which the uplink communication is transmitted.

Aspect 8: The method of Aspect 7, wherein the one or more resource elements use the first MCS.

Aspect 9: The method of Aspect 8, wherein the indication indicates a differential change from the first MCS to the second MCS.

Aspect 10: The method of Aspect 9, further comprising: receiving, prior to transmitting the indication, a configuration of a step size of the differential change.

Aspect 11: The method of Aspect 5, wherein the indication indicates a modification to a number of layers of the uplink communication.

Aspect 12: The method of Aspect 5, wherein the indication is transmitted on a resource granted by a configured grant.

Aspect 13: The method of Aspect 5, wherein the indication indicates a power control parameter associated with a transmit power of the uplink communication.

Aspect 14: The method of any of Aspects 1-13, wherein the grant indicates the first MCS and the second MCS.

Aspect 15: The method of Aspect 14, wherein the grant includes a first field indicating the first MCS and a second field indicating the second MCS.

Aspect 16: The method of Aspect 14, wherein the grant includes a field indicating the first MCS and the second MCS.

Aspect 17: The method of any of Aspects 1-16, wherein the first MCS and the second MCS are selected from a set of MCSs configured by a network node.

Aspect 18: The method of Aspect 17, wherein the set of MCSs is a proper subset of MCSs that can be indicated by the grant.

Aspect 19: The method of any of Aspects 1-18, wherein the second MCS is selected from a set of MCSs including the first MCS and a number of MCSs with lower MCS indexes than the first MCS.

Aspect 20: The method of Aspect 19, wherein the number of MCSs is configured by a network node.

Aspect 21: The method of any of Aspects 1-20, wherein the grant is configured by a configured grant (CG) configuration.

Aspect 22: The method of any of Aspects 1-21, wherein the uplink communication is associated with an extended reality (XR) application.

Aspect 23: A method of wireless communication performed by a network node, comprising: outputting a grant indicating a first modulation and coding scheme (MCS) for an uplink communication including a number of resource blocks; and obtaining, without having outputted signaling modifying the first MCS, the uplink communication on the grant using a second MCS, different than the first MCS, and including the number of resource blocks.

Aspect 24: The method of Aspect 23, wherein the first MCS is associated with a first modulation scheme and a first code rate, wherein the second MCS is associated with a second modulation scheme and a second code rate, and wherein: the first modulation scheme is higher than the second modulation scheme, or the first code rate is higher than the second code rate.

Aspect 25: The method of any of Aspects 23-24, further comprising: obtaining an indication of the second MCS.

Aspect 26: The method of Aspect 25, wherein the indication is obtained on an uplink control channel resource in a same slot as the uplink communication.

Aspect 27: The method of Aspect 25, wherein the indication is obtained on one or more resource elements of an uplink shared channel on which the uplink communication is transmitted.

Aspect 28: The method of Aspect 27, wherein the one or more resource elements use the first MCS.

Aspect 29: The method of Aspect 25, wherein the indication indicates a differential change from the first MCS to the second MCS.

Aspect 30: The method of Aspect 29, further comprising: outputting, prior to obtaining the indication, a configuration of a step size of the differential change.

Aspect 31: The method of Aspect 25, wherein the indication indicates a modification to a number of layers of the uplink communication.

Aspect 32: The method of Aspect 25, wherein the indication is obtained on a resource granted by a configured grant.

Aspect 33: The method of Aspect 25, wherein the indication indicates a power control parameter associated with a transmit power of the uplink communication, wherein obtaining the uplink communication is based at least in part on the power control parameter.

Aspect 34: The method of any of Aspects 23-33, wherein the grant indicates the first MCS and the second MCS.

Aspect 35: The method of Aspect 34, wherein the grant includes a first field indicating the first MCS and a second field indicating the second MCS.

Aspect 36: The method of Aspect 34, wherein the grant includes a field indicating the first MCS and the second MCS.

Aspect 37: The method of any of Aspects 23-36, further comprising configuring a set of MCSs from which the first MCS and the second MCS are to be selected.

Aspect 38: The method of Aspect 37, wherein the set of MCSs is a proper subset of MCSs that can be indicated by the grant.

Aspect 39: The method of any of Aspects 23-38, wherein the second MCS is selected from a set of MCSs including the first MCS and a number of MCSs with lower MCS indexes than the first MCS.

Aspect 40: The method of Aspect 39, further comprising outputting configuration information indicating the number of MCSs.

Aspect 41: The method of any of Aspects 23-40, wherein obtaining the uplink communication further comprises performing blind decoding based on at least the second MCS.

Aspect 42: The method of any of Aspects 1-22, wherein the uplink communication is a first uplink communication, and wherein the method further comprises transmitting, without having received signaling modifying the first MCS or the second MCS, a second uplink communication in accordance with the grant using a third MCS.

Aspect 43: An apparatus for wireless communication at a device, comprising a processor; memory coupled with the processor; and instructions stored in the memory and executable by the processor to cause the apparatus to perform the method of one or more of Aspects 1-42.

Aspect 44: A device for wireless communication, comprising a memory and one or more processors coupled to the memory, the one or more processors configured to perform the method of one or more of Aspects 1-42.

Aspect 45: An apparatus for wireless communication, comprising at least one means for performing the method of one or more of Aspects 1-42.

Aspect 46: A non-transitory computer-readable medium storing code for wireless communication, the code comprising instructions executable by a processor to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a grant indicating a first modulation and coding scheme (MCS) for an uplink communication including a number of resource blocks; and
transmit, without having received signaling modifying the first MCS, the uplink communication in accordance with the grant using a second MCS, different than the first MCS, the uplink communication including the number of resource blocks.

2. The UE of claim 1, wherein the one or more processors are further configured to autonomously adjust the first MCS to the second MCS prior to transmitting the uplink communication.

3. The UE of claim 1, wherein the first MCS is associated with a first modulation scheme and a first code rate, wherein the second MCS is associated with a second modulation scheme and a second code rate, and wherein:
the first modulation scheme is higher than the second modulation scheme, or
the first code rate is higher than the second code rate.

4. The UE of claim 1, wherein the uplink communication is transmitted with a first transmit power per resource block, wherein the first transmit power per resource block is lower than a second transmit power per resource block associated with the first MCS.

5. The UE of claim 1, wherein the one or more processors are further configured to:
transmit an indication of the second MCS.

6. The UE of claim 5, wherein the indication is transmitted on an uplink control channel resource in a same slot as the uplink communication.

7. The UE of claim 5, wherein the indication is transmitted on one or more resource elements of an uplink shared channel on which the uplink communication is transmitted.

8. The UE of claim 5, wherein the indication indicates a modification to a number of layers of the uplink communication.

9. The UE of claim 5, wherein the indication is transmitted on a resource granted by a configured grant.

10. The UE of claim 5, wherein the indication indicates a power control parameter associated with a transmit power of the uplink communication.

11. The UE of claim 1, wherein the grant indicates the first MCS and the second MCS.

12. The UE of claim 1, wherein the first MCS and the second MCS are selected from a set of MCSs.

13. The UE of claim 1, wherein the second MCS is selected from a set of MCSs including the first MCS and a number of MCSs with lower MCS indexes than the first MCS.

14. The UE of claim 1, wherein the grant is configured by a configured grant (CG) configuration.

15. The UE of claim 1, wherein the uplink communication is associated with an extended reality (XR) application.

16. The UE of claim 1, wherein the uplink communication is a first uplink communication, and wherein the method further comprises transmitting, without having received signaling modifying the first MCS or the second MCS, a second uplink communication in accordance with the grant using a third MCS.

17. A network node for wireless communication, comprising:
a memory; and
one or more processors, coupled to the memory, configured to:
output a grant indicating a first modulation and coding scheme (MCS) for an uplink communication including a number of resource blocks; and
obtain, without having outputted signaling modifying the first MCS, the uplink communication on the grant using a second MCS, different than the first MCS, and including the number of resource blocks.

18. The network node of claim 17, wherein the first MCS is associated with a first modulation scheme and a first code rate, wherein the second MCS is associated with a second modulation scheme and a second code rate, and wherein:
the first modulation scheme is higher than the second modulation scheme, or
the first code rate is higher than the second code rate.

19. The network node of claim 17, wherein the one or more processors are further configured to:
obtain an indication of the second MCS.

20. The network node of claim 17, wherein the one or more processors are further configured to configure a set of MCSs from which the first MCS and the second MCS are to be selected.

21. The network node of claim 17, wherein the second MCS is selected from a set of MCSs including the first MCS and a number of MCSs with lower MCS indexes than the first MCS.

22. The network node of claim 17, wherein the one or more processors, to obtain the uplink communication, are configured to perform blind decoding based on at least the second MCS.

23. A method of wireless communication performed by a user equipment (UE), comprising:
receiving a grant indicating a first modulation and coding scheme (MCS) for an uplink communication including a number of resource blocks; and
transmitting, without having received signaling modifying the first MCS, the uplink communication in accordance with the grant using a second MCS, different than the first MCS, the uplink communication including the number of resource blocks.

24. The method of claim 23, further comprising autonomously adjusting the first MCS to the second MCS prior to transmitting the uplink communication.

25. The method of claim 23, wherein the first MCS is associated with a first modulation scheme and a first code rate, wherein the second MCS is associated with a second modulation scheme and a second code rate, and wherein:
the first modulation scheme is higher than the second modulation scheme, or
the first code rate is higher than the second code rate.

26. The method of claim 23, wherein the uplink communication is transmitted with a first transmit power per resource block, wherein the first transmit power per resource block is lower than a second transmit power per resource block associated with the first MCS.

27. The method of claim 23, further comprising:
transmitting an indication of the second MCS.

28. A method of wireless communication performed by a network node, comprising:
outputting a grant indicating a first modulation and coding scheme (MCS) for an uplink communication including a number of resource blocks; and
obtaining, without having outputted signaling modifying the first MCS, the uplink communication on the grant using a second MCS, different than the first MCS, and including the number of resource blocks.

29. The method of claim 28, wherein the first MCS is associated with a first modulation scheme and a first code rate, wherein the second MCS is associated with a second modulation scheme and a second code rate, and wherein:
the first modulation scheme is higher than the second modulation scheme, or
the first code rate is higher than the second code rate.

30. The method of claim 28, further comprising:
obtaining an indication of the second MCS.
